(19) United States
(12) Patent Application Publication
(10) Pub. No.: US 2011/0116804 A1
(43) Pub. Date: May 19, 2011

(54) HANDS-FREE STERILE FIELD REMOTE CONTROL APPARATUS

(76) Inventor: Paul S. Shapiro, Birmingham, MI (US)

(21) Appl. No.: 12/946,763

(22) Filed: Nov. 15, 2010

Related U.S. Application Data
(60) Provisional application No. 61/261,484, filed on Nov. 16, 2009.

(51) Int. Cl. H04B 10/00

(52) U.S. Cl. 398/106

(57) ABSTRACT

A personal media player-recorder remote control is provided that includes an integrated circuit, an infrared transmitter electrically coupled thereto, and a power source for transmitting an infrared signal from the transmitter to a remotely located infrared receiver. A control button is provided in electrical communication with the integrated circuit and the transmitter. A housing encompasses the integrated circuit, transmitter, and power source and is formed of a material tolerant of a sterilization cycle. The remote control finds particular benefit in the setting of a surgical suite. Such a housing configured to rest on a floor need not be sterilized.

A personal media player-recorder remote control is also provided that includes the integrated circuit, the infrared transmitter, and the power source. Additionally, a microphone is coupled to the integrated circuit and power supply to relay voice commands to the integrated circuit as control signals for the infrared transmitter. A housing seals within a volume thereof the integrated circuit, the transmitter, and the power source and is formed of a sterilization cycle tolerant material.

### CROSS-REFERENCE TO RELATED APPLICATION

This application claims priority of U.S. Provisional Patent Application Ser. No. 61/261,484 filed Nov. 16, 2009, which is incorporated herein by reference.

### FIELD OF THE INVENTION

The present invention relates to remote control devices for controlling digital audio playing devices in general, and more specifically, to a remote control device which may control such a player without requiring hand operation by the listener.

### BACKGROUND OF THE INVENTION

Personal portable digital audio players allow the listener to download audio content of his choice, in various digital formats, to be played again later at his leisure. With the use of in-the-ear style headphones, several individuals may listen to their own recorded audio content in close quarters with other individuals, such as in the workplace, without disturbing those individuals. For some in the workplace, stopping work to adjust volume to a more desirable level or to turn the player on or off may be difficult or inadvisable. For surgeons in particular, doing so would compromise the sterility of the surgical field, perhaps requiring resterilization of instruments, changing of surgical gowns and gloves, and lost time, all while the patient is under anesthesia. The audio player itself is too delicate to withstand the heat and pressure of sterilization, and merely placing the audio player is a previously sterilized plastic bag would make manipulation of the device cumbersome given the conditions during surgery and the relative lack of tactile sensation due to wearing gloves. With a suitable housing, however, a remote control device for such a player may withstand sterilization.

Additionally, personal audio-video player-recorders are becoming seen in the operating room for collection and playing of scope images or pre-surgical scan images.

In light of these problems, there exists a need for an autoclavable remote control device operating a digital media player-recorder or, in the alternative, for a foot pedal or voice operated remote control device for such a player.

### SUMMARY OF THE INVENTION

A personal media player-recorder remote control is provided that includes an integrated circuit, an infrared transmitter electrically coupled thereto, and a power source for transmitting an infrared signal from the transmitter to a remotely located infrared receiver. A control button is provided in electrical communication with the integrated circuit and the transmitter. A housing encompasses the integrated circuit, transmitter, and power source and is formed of a material tolerant of a sterilization cycle. The remote control finds particular benefit in the setting of a surgical suite. Such a housing configured to rest on a floor need not be sterilized.

A personal media player-recorder remote control is also provided that includes the integrated circuit, the infrared transmitter, and the power source. Additionally, a microphone is coupled to the integrated circuit and power supply to relay voice commands to the integrated circuit as control signals for the infrared transmitter. A housing seals within a volume thereof the integrated circuit, the transmitter, and the power source and is formed of a sterilization cycle tolerant material.

### BRIEF DESCRIPTION OF THE DRAWINGS

FIG. 1 shows a perspective partial cutaway illustration of the front of the remote control housing with the control buttons and with the outlined areas demonstrating the interior locations of the remote control hardware and battery compartment.

FIG. 2 shows the same perspective as in FIG. 1, but with an enhanced view of the control buttons.

FIG. 3 shows a view of the remote control housing along its longest dimension showing the seam between top and bottom portions of the housing.

FIG. 4 shows the bottom of the remote control housing where the door to the battery compartment is found.

FIG. 5 shows the top view of an alternative, foot-operated design with an on/off switch in the middle and the control buttons arranged around the perimeter of the on/off button.

FIG. 6 shows a side view of FIG. 5.

FIG. 7 shows the bottom view of FIG. 5 with the door for the battery compartment.

### DETAILED DESCRIPTION OF THE PREFERRED EMBODIMENTS

The invention has utility as a remote control for a personal media player-recorder, and finds particular utility in and around a sterile field. An autoclavable housing of the inventive remote control device allows a user operating in a sterile field or setting where hands cannot be removed to play or record an audio or video presentation and control volume without compromising the sterile field as the remote control for the digital media player-recorder may itself be sterilized. Additionally, the autoclavable remote control may permit the listener to turn the digital media player-recorder on or off, or skip forward or backward in the file list to another selection. The remote control has a housing made of transparent high temperature plastic which withstands the heat, steam, and pressure which normally accompanies sterilization in an autoclave. The transparency of the housing permits transmission of the infrared signal from the remote control to the infrared receiver located on the digital media player-recorder. The seam between the top and bottom halves of the housing is sealed with a suitable heat/steam/pressure-resistant sealant. On the underside of the remote control unit is a battery compartment which can accommodate the button-type battery commonly used in remote control devices associated with digital audio players. A foot pedal operated remote control placed upon the floor underneath the sterile field is also contemplated. In an alternative embodiment, a remote controller is voice activated to in turn operate the digital audio playing device. Additionally, these alternatives have non-surgical application where anyone performing a task requiring the simultaneous use of both hands cannot stop the work to adjust the volume of the audio presentation or turn the player-recorder on or off.

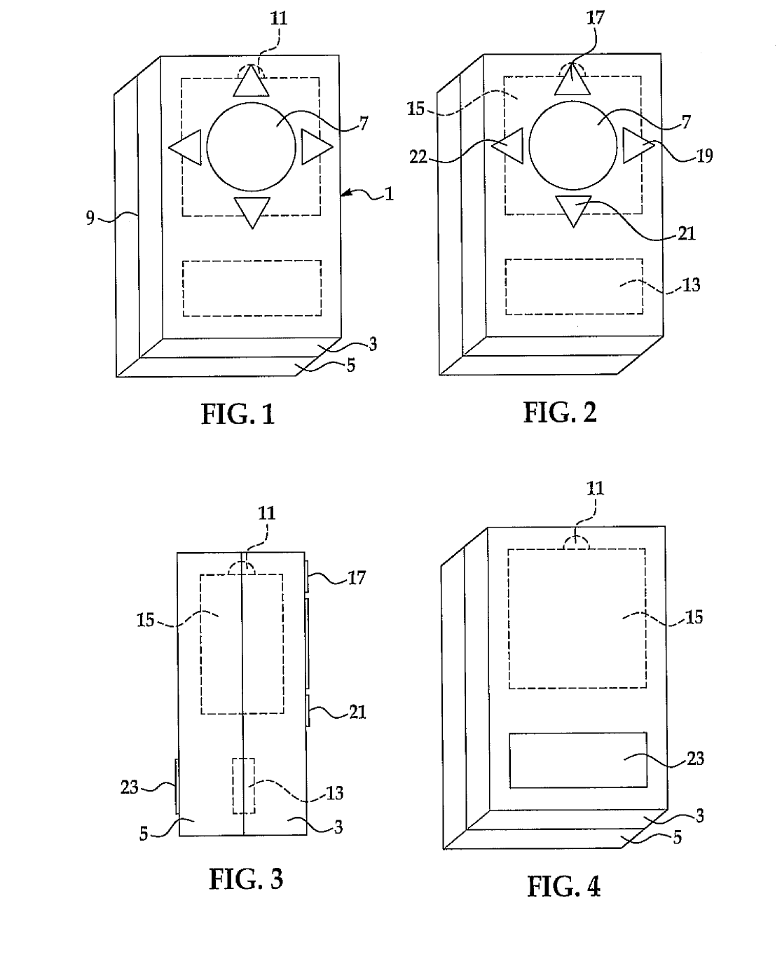

Referring particularly to FIG. 1, remote control housing 1 is composed of a material capable of withstanding the heat, steam, and pressure of a typical autoclave sterilization cycle such as ceramic, glass, stainless steel, or more preferably, transparent high temperature plastic. Remote control housing 1 includes a top portion 3 and a bottom portion 5 hermetically sealed together along seam 9 with an appropriate bonding agent. The remote control housing 1 is optionally contoured to fit comfortably in the hand. The housing 1 encompasses an integrated circuit (IC) 102 coupled to an infrared transmitter 104. Both the IC 102 and transmitter 104 are powered by a power source 106 such as a button-type or other type of battery or series of batteries. FIG. 2 shows the same view and orientation as FIG. 1 but includes the control panel of the remote control typically having a volume up button 17, and a volume down button 21, but more preferably also featuring an on/off button 7, and a previous selection button 22 and a next selection button 19. It is appreciated that in addition to or in lieu of the aforementioned buttons, an aperture 2 is provided to allow for sound to enter a voice activation microphone 108 within the housing 1. As shown in FIGS. 2 and 3, when assembled and sealed together, top portion 3 and bottom portion 5 of remote control housing 1 define a space 15 sufficient to accommodate remote control transmitter electronics 104, IC 102, and a space 13 sufficient to accommodate a battery power source 106. The remote control electronics and the infrared LED 11 are completely contained within the electronics compartment 15 of the remote control housing 1. The transparency of the clear high temperature plastic permits the infrared signal to exit the housing 1 and be transmitted to an infrared receiving apparatus located in a personal digital media player-recorder at some distance from the user. In the event that some autoclavable material impenetrable by infrared waves is used to construct remote control housing 1, a window of transparent material, such as transparent high temperature plastic or transparent polypropylene plastic, will be needed to permit the infrared signal to be transmitted to the digital media player-recorder. As shown in FIG. 4, the door to battery compartment 23 permits the user access to the battery compartment to change the battery of the remote control when necessary. The interior perimeter of the battery compartment door may be lined with an autoclavable material, preferably an appropriate rubber or polypropylene plastic (not shown) to form an impenetrable barrier when closed to protect interior components from the effects of heat and steam during sterilization. The battery compartment door 23 may be closable by any number of means provided that upon closing, the battery compartment door forms a seal between it and the battery compartment 13 of the remote control housing 1 which protects the interior components of the remote control from heat, steam, and pressure and that any hardware used to secure battery compartment door 23 be resistant to heat, steam, and pressure. It is appreciated that an aperture, such as 2, is readily formed in bottom portion 5 or compartment door 23 to provide sound to enter the interior of a housing 1 containing a microphone for receiving and relaying voice commands to operate a digital audio player.

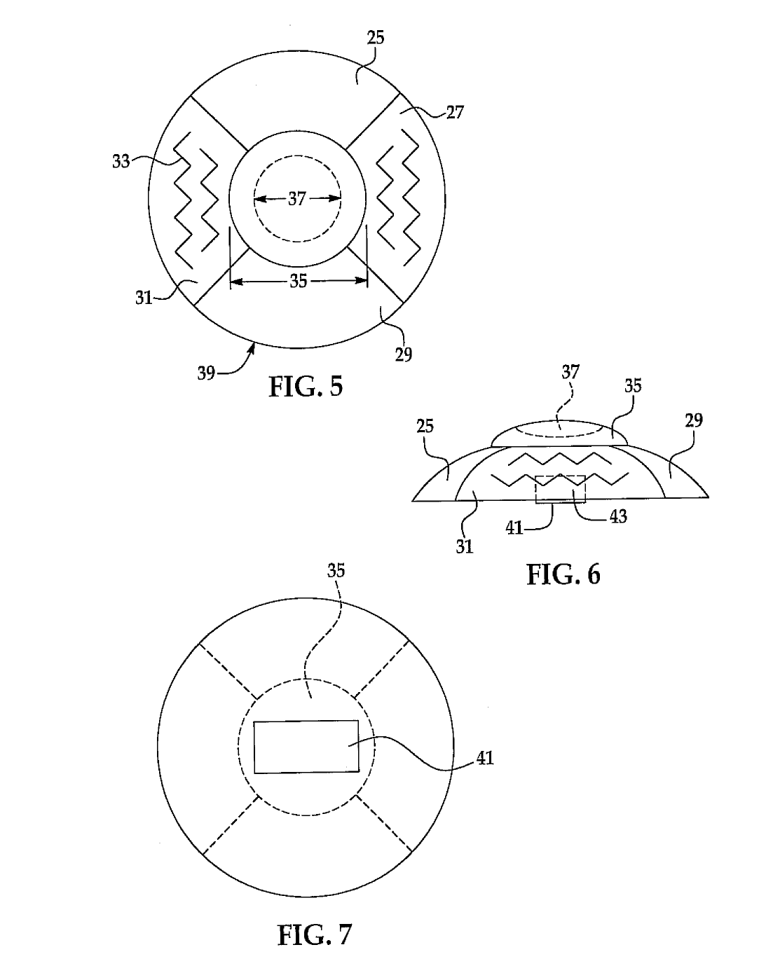

FIG. 5 is a view from above of an alternate form of the invention which rests on the floor. FIG. 5 shows a circular, disc-shaped, foot manipulated remote control 39 with a housing made of hard plastic or, more preferably, stainless steel. FIG. 6 is a side, or edge, view of FIG. 5 showing the compartment 37 of the remote control 39 located on the inside surface of the exterior portion of the on/off button 35 which accommodates the remote control electronics and the infrared LED. That portion of the remote control 39 covering the on/off button 35 is preferably transparent to facilitate transmission of an infrared signal from the infrared LED 37, to a personal digital media player-recorder located some distance away. FIG. 5 shows the remote control 39 with an on/off button 35 at the center of the remote control 39. The remote control 39 typically has a volume up pedal 25, and a volume down pedal 29, each comprising a semicircular shaped pedal arranged around the perimeter of the on/off button 35, and more preferably features a previous selection button 31 and a next selection button 27. In the latter configuration, the four pedals are arranged around the perimeter of the on/off button 35 in quarter circle portions as pictured in FIG. 5. Either pair of the volume or selection pedals may bear three-dimensional texturing or ridges 33 in the surface of the pedal to facilitate identification of a particular pedal by touch without requiring the listener to look away from his work. FIG. 7 is a view of the bottom of the remote control 39 showing the battery compartment door 41 leading to the battery compartment 43 shown in FIG. 6. The battery compartment door 23 is closable by any number of means and the battery compartment 43 is appreciated to be as large as needed to accommodate as many batteries of the required size as is necessary to produce an infrared signal of sufficient strength to reach the infrared receiver located at some distance away in the digital media player-recorder.

The foregoing description is illustrative of particular embodiments of the invention, but is not meant to be a limitation upon the practice thereof. The following claims, including all equivalents thereof, are intended to define the scope of the invention.

1. A personal media player-recorder remote control comprising:
an integrated circuit;
an infrared transmitter electrically coupled to said integrated circuit;
a power source electrically coupled to said infrared transmitter, said transmitter transmitting an infrared signal to a remotely located infrared receiver;
a control button in electrical communication with said integrated circuit and said transmitter, said control button comprising at least one control of: on/off, auditory volume up, auditory volume down, previous selection, or next selection buttons; and
a housing defining a volume and made of a material tolerant of a sterilization cycle, said housing sealing within the volume said integrated circuit, said transmitter and said power source.

2. The remote control of claim 1 further comprising a divider within said housing yielding an interior electronics compartment accommodating said integrated circuit and infrared transmitter, said electronics compartment being sealed against external autoclave steam and pressure, and an interior battery compartment accommodating said power supply.

3. The remote of claim 2 further comprising a battery compartment door accessing said power source.

4. The remote control of claim 1 wherein said set of control buttons are configured as foot pedals and said housing is adapted to operate on a floor with foot pressure.

5. The remote control of claim 1 wherein said foot pedals are textured.

6. A personal media player-recorder remote control comprising:
an integrated circuit;
an infrared transmitter electrically coupled to said integrated circuit;
a power source electrically coupled to said infrared transmitter, said transmitter transmitting an infrared signal to a remotely located infrared receiver;
a control button configured as a foot pedal in electrical communication with said integrated circuit and said transmitter, said control button comprising at least one control of: on/off, auditory volume up, auditory volume down, previous selection, or next selection buttons; and
a housing configured to rest on a floor and defining a volume, said housing containing within the volume said integrated circuit, said transmitter and said power source.

7. The remote control of claim 6 wherein said housing is made of a material tolerant of a sterilization cycle.

8. The remote control of claim 6 wherein the volume is hermetically sealed.

9. A personal media player-recorder remote control comprising:
an integrated circuit;
an infrared transmitter electrically coupled to said integrated circuit;
a power source electrically coupled to said infrared transmitter, said transmitter transmitting an infrared signal to a remotely located infrared receiver;
a microphone coupled to said integrated circuit and said power supply, said microphone relaying voice commands to said integrated circuit as control signals to said infrared transmitter; and
a housing defining a volume and made of a material tolerant of a sterilization cycle, said housing sealing within the volume said integrated circuit, said transmitter and said power source.

10. The remote of claim 9 further comprising a control button in electrical communication with said integrated circuit and said transmitter, said control button comprising at least one control of: on/off, volume up, volume down, previous selection, or next selection buttons.

11. The remote of claim 9 wherein said housing defines an aperture.

12. The remote of claim 11 wherein the aperture is in overlying proximity with said microphone.

13. The remote control of claim 9 wherein said housing is made of a material tolerant of a sterilization cycle.

14. The remote control of claim 9 wherein the volume is hermetically sealed.
